(19) United States
(12) Patent Application Publication
(10) Pub. No.: US 2010/0304048 A1
(43) Pub. Date: Dec. 2, 2010

(54) FLEXIBLE TRANSPARENT CONDUCTIVE FILM, FLEXIBLE FUNCTIONAL DEVICE, AND METHODS FOR PRODUCING THESE

(76) Inventors: Masaya Yukinobu, Chiba (JP); Yuki Murayama, Chiba (JP)

Correspondence Address: KRATZ, QUINTOS & HANSON, LLP, 1420 K Street, N.W., 4th Floor, WASHINGTON, DC, 20005, US

(21) Appl. No.: 12/745,040

(22) PCT Filed: Feb. 13, 2009
(86) PCT No.: PCT/JP2009/052942

§ 371 Date: May 27, 2010

(30) Foreign Application Priority Data
Feb. 13, 2008 (JP) 2008-031323
May 16, 2008 (JP) 2008-129153

(51) Int. Cl. B32B 27/06; B32B 38/00; C09K 19/00; B32B 38/10

(52) U.S. Cl. 428/1.1; 428/337; 156/280; 156/230

(57) ABSTRACT

In a flexible transparent conductive film having a base film and a transparent conductive layer formed by coating the base film surface with a transparent conductive layer forming coating fluid, the base film is constituted of a plastic film of 3 to 50 μm in thickness having been provided with gas barrier function, the flexible transparent conductive film has a backing film laminated to one side of the base film in such a way as to be peelable at the interface thereof with the base film, the transparent conductive layer provided on the base film surface on its side opposite to the backing film is chiefly composed of conductive fine oxide particles and a binder matrix, and the transparent conductive layer has been subjected to compressing together with the base film and the backing film. Also disclosed is a flexible functional device which has the above flexible transparent conductive film and formed thereon any functional device selected from a liquid-crystal display device, an organic electroluminescent device, a dispersion-type inorganic electroluminescent device and an electronic paper device.

### TECHNICAL FIELD

This invention relates to a flexible transparent conductive film having a base film and provided on the surface thereof a transparent conductive layer, and to a flexible functional device such as a liquid-crystal display device, an organic electroluminescent device, a dispersion-type inorganic electroluminescent device or an electronic paper device, obtained by using this flexible transparent conductive film. More particularly, this invention relates to improvements in a flexible transparent conductive film and a flexible functional device, which have gas barrier function and a superior flexibility.

### BACKGROUND ART

In recent years, in various displays including liquid-crystal display devices and in electronic equipments such as cellular telephones, there is an increasing trend toward light-weight, thin-gauge and small-sized ones. With this trend, studies are energetically made on how glass substrates having conventionally been used are replaced by plastic films. The plastic films are light and have an excellent flexibility, and hence thin plastic films of about several μm in thickness may be used as substrates of, e.g., a liquid-crystal display device, an organic electroluminescent device (hereinafter also simply “organic EL device”), a dispersion-type inorganic electroluminescent device (hereinafter also simply “dispersion-type inorganic organic EL device”) and an electronic paper device. If so, flexible functional devices may be obtained which are very light-weight and flexible.

As a flexible transparent conductive film used in such flexible functional devices, a plastic film is widely known on which a transparent conductive layer of an indium-tin oxide (hereinafter simply “ITO”) (the layer is hereinafter simply “ITO layer”) has been formed by a physical vapor deposition process such as sputtering or ion plating (hereinafter simply “sputtered ITO film”).

The sputtered ITO film is a film obtained by forming as an inorganic component an ITO single layer on a transparent plastic film of polyethylene terephthalate (PET), polyethylene naphthalate (PEN) or the like by the physical vapor deposition process such as sputtering in a thickness of about 10 nm to 50 nm. This enables a transparent conductive layer to be obtained which has a low resistivity of about 100 to 500 Ω/square (ohm per square; the same applies hereinafter) as surface resistivity.

However, the sputtered ITO film is a thin film formed of an inorganic component, which is very brittle, and hence it has a problem that micro-cracks tend to come about. Accordingly, where the sputtered ITO film is formed on a base film of less than 50 μm (e.g., 25 μm) in thickness and this is used in the above flexible functional device, the base film is so highly flexible as to cause cracks in the sputtered ITO film during handling or after the flexible functional device has been set up, resulting in great damage of the conductivity of the film. Thus, under existing circumstances, such a film has not been put into practical use in the flexible functional device required to have a high flexibility.

Hence, in place of the above method in which the ITO film is formed by the physical vapor deposition process such as sputtering, a method is proposed in which a transparent conductive layer is formed on the surface of a base film by using a transparent conductive layer forming coating fluid, as in the invention disclosed in, e.g., Japanese Patent Laid-open Application No. H04-237909 (Patent Document 1), No. H05-036314 (Patent Document 2), No. 2001-321717 (Patent Document 3), No. 2002-36411 (Patent Document 4) or No. 2002-42558 (Patent Document 5). Stated specifically, it is a method in which a base film is coated thereon with a transparent conductive layer forming coating fluid composed chiefly of conductive fine oxide particles and a binder, followed by drying to form a coating layer and then compressing (rolling) by means of metal rolls, and thereafter the binder component is hardened or cured to produce a transparent conductive film having the transparent conductive layer. This method has an advantage that the conductive fine oxide particles in the transparent conductive layer can be filled in a higher density by the aid of the rolling making use of metal rolls and the layer can vastly be improved in its electrical (conductive) properties and optical properties.

Further, in the invention disclosed in Japanese Patent Laid-open Application No. 2006-202738 (Patent Document 6), No. 2006-202739 (Patent Document 7) or WO2007/039969 (Patent Document 8), a transparent conductive film is proposed which is a transparent conductive film formed using a transparent conductive layer forming coating fluid, and has good handling properties although a very thin base film is used, which is provided with a backing film having a weak pressure-sensitive adhesive layer that is peelable at its interface with the base film; the backing film being laminated to the transparent conductive film on its base film side.

Now, in the flexible functional devices such as a liquid-crystal display device, an organic electroluminescent device, a dispersion-type inorganic electroluminescent device or an electronic paper device which are obtained by using the above transparent conductive film, gas barrier function against water vapor, oxygen gas and so forth is required in many cases (provided that, in the dispersion-type inorganic electroluminescent device, the gas barrier function is not particularly required where a moisture-proof coated product is used as phosphor particles). Accordingly, a method is studied in which, e.g., a commercially available gas-barring plastic film having been provided with gas barrier function is laminated to the transparent conductive film via an adhesive layer to make the transparent conductive film have the gas barrier function.

However, the method in which the gas-barring plastic film is laminated to the transparent conductive film has a problem that the thickness of the adhesive layer is added to the thickness of the gas-barring plastic film and hence, correspondingly thereto, the final thickness of the functional device comes so large as to make the functional device have a poor flexibility. Further, there has been a problem that such a method can not meet the demand that the thickness of the device must be made as small as possible in setting the functional device in a thin-gauge equipment such as a card (IC card, credit card, prepaid card, etc.).

Further, in the invention described in Japanese Patent Laid-open Application No. 2006-156250 (Patent Document 9), a transparent electric conductor (transparent conductive film) is proposed which includes a substrate (base film) having a barrier layer containing a metal or an inorganic compound, and provided on the substrate a conductive layer containing conductive particles and a resin.

However, in the invention described in the Patent Document 9, the barrier layer has a role to restrict permeation of a moisture, solvent, organic gas, or the like, which swells the substrate, into the substrate, and the invention described in the Patent Document 9 aims at preventing elongation of the conductive layer to be otherwise caused by swelling of the substrate. That is, it aims at preventing elongation of the conductive layer to prevent breakage at joining points between conductive particles, in a manner to restrict an increase, a timewise change, or the like of an electrical resistance of the conductive layer in an environment of high humidity or in an environment of chemical substance. Thus, in the invention described in the Patent Document 9, it is not intended to provide the electric conductor with a flexibility, and a PET film having a thickness of 100 μm is used as the substrate in all the Examples of the Patent Document 9.

Further, in the invention described in the Patent Document 9, it is intended to restrict permeation of gas into the substrate (base film) in a manner to stabilize a resistance value of the transparent conductive layer and to use the transparent conductor in a touch panel, and it is never intended to provide the transparent conductive film with gas barrier function in a manner to use the transparent conductor in various flexible functional devices. Note that specific values are never described in the invention described in the Patent Document 9 which are related to gas barrier function (such as water vapor transmission rate) of the transparent conductive film itself which is required when the transparent electric conductor (transparent conductive film) is to be used in various flexible functional devices. Furthermore, although the Patent Document 9 provides a description in its paragraph [0072] that the conductive layer may be provided as a compressed layer, this compressed layer is formed by belatedly laminating a conductive layer, which has been previously compressed, to the substrate having the barrier layer, and thus no knowledges are provided about an affection on a barrier function when the conductive layer is subjected to compressing together with the substrate (base film) having the barrier layer.

### DISCLOSURE OF THE INVENTION

The present invention has been made taking note of such problems. What are aimed herein are to provide a flexible transparent conductive film and a flexible functional device which have gas barrier function and a superior flexibility, and in addition thereto to provide methods for producing these flexible transparent conductive film and flexible functional device.

Accordingly, in order to resolve the above problems, in place of the above method in which the gas-barring plastic film is laminated to the transparent conductive film, the present inventors have directly employed as a base film a plastic film of 3 to 50 μm in thickness having been provided with gas barrier function; laminated, to one side of the base film, a backing film peelable at the interface thereof with the base film; coated the base film surface on its side opposite to the backing film, with a transparent conductive layer forming coating fluid, to form a coating layer; and subjected the base film on which the coating layer has been formed, the base film having the backing film on its one side, to compressing to directly form thereon a transparent conductive layer having a superior flexibility. As the result, they have come discovered that, contrary to what is expected at first, a flexible transparent conductive film having gas barrier function and a superior flexibility can be obtained with ease, without observing deterioration of gas barrier function due to the compressing. The present invention has been accomplished on the basis of such a technical discovery.

That is, the flexible transparent conductive film according to the present invention is:

a flexible transparent conductive film having a base film and a transparent conductive layer formed by coating the base film surface with a transparent conductive layer forming coating fluid, wherein;

the base film is constituted of a plastic film of 3 to 50 μm in thickness having been provided with gas barrier function, the flexible transparent conductive film has a backing film laminated to one side of the base film in such a way as to be peelable at the interface thereof with the base film, the transparent conductive layer provided on the base film surface on its side opposite to the backing film is chiefly composed of conductive fine oxide particles and a binder matrix, and the transparent conductive layer has been subjected to compressing together with the base film and the backing film.

The method for producing a flexible transparent conductive film according to the present invention comprises:

laminating, to one side of a base film constituted of a plastic film of 3 to 50 μm in thickness, having been provided with gas barrier function, a backing film in such a way as to be peelable at the interface thereof with the base film;

coating the base film surface on its side opposite to the backing film, with a transparent conductive layer forming coating fluid composed chiefly of conductive fine oxide particles, a binder and a solvent, to form a coating layer;

subjecting the base film on which the coating layer has been formed, the base film having the backing film on its one side, to compressing; and thereafter

curing the coating layer to form a transparent conductive layer.

Then, the flexible functional device according to the present invention comprises:

the above flexible transparent conductive film and formed on its side opposite to the backing film any functional device selected from a liquid-crystal display device, an organic electroluminescent device, a dispersion-type inorganic electroluminescent device and an electronic paper device; the backing film having been removed by peeling the same at the interface thereof with the base film.

The method for producing a flexible functional device according to the present invention comprises:

forming on the above flexible transparent conductive film and on its side opposite to the backing film any functional device selected from a liquid-crystal display device, an organic electroluminescent device, a dispersion-type inorganic electroluminescent device and an electronic paper device; and

removing the backing film by peeling the same at the interface thereof with the base film.

According to the flexible transparent conductive film according to the present invention, the plastic film having been provided with gas barrier function is directly used as the base film of a transparent conductive film, and also, on the surface of the plastic film having been provided with gas barrier function, a transparent conductive layer having a superior flexibility is directly formed by using a transparent conductive layer forming coating fluid. Hence, it has gas barrier function and a superior flexibility.

According to the flexible functional device according to the present invention, any functional device selected from a liquid-crystal display device, an organic electroluminescent device, a dispersion-type inorganic electroluminescent device and an electronic paper device is formed on the flexible transparent conductive film having gas barrier function and a superior flexibility, thus the thickness of the flexible functional device is kept relatively small. Hence, it has a superior flexibility, and, e.g., this makes it easy to set it in a thin-gauge equipment such as a card, and further can contribute to the materialization of more thin-gauge equipments.

### BRIEF DESCRIPTION OF THE DRAWING

FIG. 1 is a schematic explanatory view of an embodiment of a method for producing a flexible transparent conductive film according to the present invention.

### BEST MODES FOR PRACTICING THE INVENTION

The present invention is described below in detail.

First, the flexible functional device in which the flexible transparent conductive film according to the present invention is to be used may include the above liquid-crystal display device, organic EL device, dispersion-type inorganic EL device and electronic paper device.

In any of such functional devices, the transparent conductive film to be used is required to have gas barrier function (such as an oxygen barrier or a water vapor barrier). For example, as the water vapor barrier, a water vapor transmission rate (WVTR) of about 0.1 g/m²/day or less, and preferably 0.01 g/m²/day or less, is deemed to be necessary (provided that, in a dispersion-type inorganic EL device making use of moisture-proof coated encapsulated phosphor particles, the device is not required to be made moisture-proof as stated above). Usually, a method is employed in which a gas-barring plastic film is laminated to each functional device via an adhesive. Meanwhile, making functional devices thin-gauge, light-weight and rich in flexibility has increasingly come to be of important subject, and it is sought to make devices as thin as possible.

Accordingly, a thin and flexible gas-barring plastic film (a plastic film having been provided with gas barrier function) is directly employed as a base film and also, on the plastic film having been provided with gas barrier function (the base film), a transparent conductive layer having a superior flexibility is directly formed by using a transparent conductive layer forming coating fluid. In such a case, the transparent conductive film obtained can both be provided with gas barrier function and have a superior flexibility, and this can resolve the above problems. The present invention is based on such a thought.

Here, in the flexible transparent conductive film of the present invention, as mentioned above a transparent conductive layer composed chiefly of conductive fine oxide particles and a binder matrix is directly formed on the plastic film having been provided with gas barrier function (the base film), by coating (i.e., by a method of forming the transparent conductive layer by using a transparent conductive layer forming coating fluid).

As a method by which the plastic film is provided with gas barrier function, a method is prevalent in which the plastic film is subjected to gas barrier coating. For example, known as gas-barring plastic films used in packaging materials and liquid-crystal display devices are a film on which silicon oxide has been vacuum-deposited (see Japanese Patent Publication No. S53-12953: Patent Document 10) and a film on which aluminum oxide has been vacuum-deposited (see Japanese Patent Laid-open Application No. S58-217344: Patent Document 11). These, however, have water vapor barrier properties of about 1 g/m²/day in WVTR. In recent years, however, film base materials are required to have much higher gas barrier properties as organic EL display or liquid-crystal display devices have come to be of larger size and higher definition, and are sought to have function such that they have gas barrier properties of less than 0.1 g/m²/day in WVTR. To cope with this, studies are made on film formation carried out by sputtering or CVD, in which thin films are formed using plasma generated by glow discharging under low-pressure conditions. A technique is further proposed in which a barrier film which is so structured that organic films and inorganic films are alternately layered with one another is formed by a vacuum deposition process or a discharge plasma process carried out under a pressure close to atmospheric pressure (see WO2000/026973: Patent Document 12 and Japanese Patent Laid-open Application No. 2003-191370: Patent Document 13). As one having water vapor barrier properties of 0.001 g/m²/day or less in WVTR, a gas-barring thin-film multilayer structure is also proposed in which two or more ceramic films are layered (see Japanese Patent Laid-open Application No. 2007-277631: Patent Document 14).

As the plastic film (the base film) having been provided with gas barrier function (such as a water vapor barrier or an oxygen barrier) in the present invention, any of commercially available gas-barring plastic films may be used which are obtained by various methods disclosed in the above Patent Document 10 to Patent Document 14, and preferably, the gas barrier coating comprises at least one vapor-deposited film made of an inorganic material and at least one coated film containing an organic material, the vapor-deposited film and the coated film being layered with each other. Incidentally, to simultaneously establish a gas barrier function and a flexibility in the gas barrier coating comprising the layered vapor-deposited film and coated film, the vapor-deposited film is to preferably have a thickness of 5 to 100 nm, and the coated film is to preferably have a thickness of 0.1 to 1 μm. This is because, excessively large thicknesses of either the vapor-deposited film or the coated film result in a deteriorated flexibility, and excessively small thicknesses result in a deteriorated gas barrier function. Note that the vapor-deposited film in the gas barrier coating is used in the present invention as a concept to mean a film formed by a vapor deposition process in a broad sense, in a manner to embrace, in addition to a vacuum-deposited film, a sputtered film, a chemically vapor deposited film (CVD film) and the like, for example. The gas type or gas barrier function to be required may differ depending on the types of the functional devices, such that although both an oxygen barrier and a water vapor barrier are required in an organic EL device, a water vapor barrier is required but an oxygen barrier is not required in an electrophoretic type of electronic paper device, for example. Further, in the case of organic EL devices or liquid-crystal display devices, the base film is required to have water vapor barrier properties of 0.01 g/m²/day or less in WVTR, and preferably 0.001 g/m²/day or less in WVTR. However, films having a high gas barrier function are commonly expensive. Accordingly, the base film may appropriately be selected in accordance with the type of the functional device to be used, the equipment in which the functional device is to be used and the service environment, tolerance lifetime and so forth of the equipment.

The plastic film having been provided with gas barrier function (the base film) as used in the present invention may have a thickness of from 3 μm to 50 μm, and preferably from 6 μm to 25 μm. With an increase in thickness of the base film, the base film may commonly have a higher rigidity and may damage the flexibility the flexible functional device should have. On the other hand, with a decrease in thickness of the base film, the flexible functional device may be improved in flexibility, but tends to bring a difficulty in handling in the production steps, resulting in poor productivity in some cases. In particular, if the base film has a thickness of less than 3 μm, such a base film is undesirable because there are problems that any general-purpose film commonly distributed may be obtained with difficulty, that the base film itself may be very difficult to handle, to make the backing difficult that is provided using a support film (backing film) described later, and that the base film itself has a low strength to cause damage in device components inclusive of gas barrier films and transparent conductive layers of flexible functional devices.

Materials for the base film (the plastic film having been provided with gas barrier function) are not particularly limited as long as they have transparency or light-transmission properties and also are those on which the transparent conductive layer can be formed. Various plastic films may be used. Stated specifically, usable are plastic films of polyethylene terephthalate (PET), polyethylene naphthalate (PEN), nylon, polyether sulfone (PES), polycarbonate (PC), polyethylene (PE), polypropylene (PP), urethane, fluorine type resins and so forth. Of these, PET film is preferred from the viewpoints of, e.g., being inexpensive and of good strength and having transparency and flexibility together.

As the base film (the plastic film having been provided with gas barrier function), a film may also be used which has been reinforced with inorganic and/or organic (plastic) fibers (inclusive of acicular, rod-like or whiskery fine particles) or flaky fine particles (inclusive of plate-like ones). The base film reinforced with such fibers or flaky fine particles can have a good strength even though it is a thinner film.

In order to improve adhesion to the transparent conductive layer composed chiefly of conductive fine oxide particles and a binder matrix, the base film (the plastic film having been provided with gas barrier function) may previously be subjected to adhesion-promoting treatment as exemplified by plasma treatment, corona discharge treatment or short-wavelength ultraviolet irradiation treatment, on its surface to be coated with the transparent conductive layer forming coating fluid.

Here, in the case when the plastic film having been subjected to the above gas barrier coating is used as the plastic film having been provided with gas barrier function, the transparent conductive layer may be formed on either side of the plastic film. For example, where the transparent conductive layer is formed on a gas barrier layer of the plastic film having been subjected to the gas barrier coating, a structure comes in which the gas barrier layer is held between the plastic film and the transparent conductive layer, where the gas barrier layer does not stand bare to the outside, and hence (i.e., it is protected by the plastic film and transparent conductive layer, and hence) the gas barrier layer can not easily come to deteriorate because of scratches or chemicals. However, forming the transparent conductive layer on the gas barrier layer of the plastic film having been subjected to the gas barrier coating may make it more difficult to secure the adhesion between them than forming the transparent conductive layer on the plastic film. In this regard, there may be a possibility that the transparent conductive layer forming coating fluid affects the gas barrier layer adversely, and hence appropriate selection must be made in accordance with the type of the device in which the flexible transparent conductive film is to be used and how it is used.

The plastic film having been provided with gas barrier function may also be laminated to each other in plurality to make up the base film so as to make the base film have a stronger gas barrier function. For example, two sheets of gas-barring plastic film having water vapor barrier properties of 0.1 g/m²/day in WVTR may be laminated to each other, where water vapor barrier properties of 0.05 g/m²/day in WVTR can be achieved. However, laminating to each other a plurality of plastic films having been provided with gas barrier function makes the base film have a larger total thickness to have a lower flexibility, correspondingly thereto. Accordingly, whether the base film should be made up of a single plastic film having been provided with high-performance gas barrier function or the base film should be made up of a plurality of inexpensive gas-barring plastic films (plastic films having been provided with gas barrier function) laminated to each other may appropriately be judged in accordance with the cost, the thickness of the functional device to be used, the flexibility to be required, and so forth.

The base film (the plastic film having been provided with gas barrier function) may be subjected to hard coating, antiglare coating or antireflection (low-reflection) coating on its side on which the transparent conductive layer is not formed. The side on which the transparent conductive layer is not formed serves finally as the outermost surface of the flexible functional device according to the present invention (what is obtained by forming a functional device on the transparent conductive layer of the flexible transparent conductive film) and comes bare to the outside, and hence such a surface having been subjected to hard coating comes improved in wear resistance. Thus, for example, this can effectively prevent the gas barrier function from lowering because of any scratching of the gas barrier coating layer, and the flexible functional device from lowering in its display performance. Similarly, the surface having been subjected to antiglare coating or antireflection coating can keep any outside light from reflecting from the outermost surface of the flexible functional device, to enable more improvement in display performance.

Now, the base film (the plastic film having been provided with gas barrier function) has a thickness of as small as from 3 μm to 50 μm as described above. Accordingly, taking account of the handling and productivity of the flexible transparent conductive film and flexible functional device in their production steps, it is required for the base film to be backed (reinforced) with a support film (backing film). For example, it is undesirable to use the thin base film by itself without backing it by a support film (backing film) in the case of using the base film in a roll-to-roll manufacturing process, because the base film is then meandered or deflected to considerably complicate transference of the base film, and simultaneously therewith, distortion, wrinkle, and the like are caused in the base film in a rolling (compressing) process as well, to be described later. It is desirable for this support film (backing film) to have, on its surface joining to the base film, a weak pressure-sensitive adhesive layer that is peelable after bonding. Incidentally, not stated commonly, where the material itself of the support film (backing film) is weakly pressure-sensitive, the support film (backing film) serves also as the weak pressure-sensitive adhesive layer, and hence the weak pressure-sensitive adhesive layer need not be formed.

Here, the support film (backing film) may have a thickness of 50 μm or more, preferably 75 μm or more, and more preferably 100 μm or more. This is because, if the support film (backing film) has a thickness of less than 50 μm, the film may have a low rigidity to bring about a difficulty in handling various flexible functional devices in their production steps and further may tend to cause the problem of the curling of the base material or cause a problem when, e.g., functional device layers are formed (e.g., when phosphor layers or the like are formed by multi-layer printing in a dispersion-type inorganic EL device). Meanwhile, the support film (backing film) may preferably have a thickness of 200 μm or less. This is because, if the support film (backing film) has a thickness of more than 200 μm, the film may come so hard and heavy as to be difficult to handle, and at the same time may be undesirable in view of cost.

As to materials for the support film (backing film), there are no particular limitations thereon, and various plastic films may be used. Stated specifically, usable are plastic films of polycarbonate (PC), polyethylene terephthalate (PET), polyethylene naphthalate (PEN), nylon, polyether sulfone (PES), polyethylene (PE), polypropylene (PP), urethane, fluorine type resins, polyimide (PI) and so forth. Of these, PET film is preferred from the viewpoints of, e.g., being inexpensive and of good strength and having flexibility together. The transparency of the support film (backing film) is not directly concerned with the transparency required for the flexible functional device. However, a transparent film is preferred because devices may be examined as products through the support film to inspect their characteristics (such as brightness, external appearance and display performance). Thus, in this regard as well, the PET film is preferred.

The support film (backing film) undergoes the steps of producing the flexible transparent conductive film and flexible functional device, in the state it is kept in close contact with the base film, and then it is finally peeled from the base film. Accordingly, it is preferable for the above weak pressure-sensitive adhesive layer to have an appropriate releasability. Materials for such a weak pressure-sensitive adhesive layer may include acrylic or silicone type materials. Of these, a silicone type weak pressure-sensitive adhesive layer is preferred because of an advantage that the silicone type weak pressure-sensitive adhesive layer has a superior heat resistance.

As the releasability required for the weak pressure-sensitive adhesive layer, stated specifically, it is desirable that the peel strength (the force necessary for the peeling per unit length at the peel portion) to the base film in a 180° peel test (tensile speed: 300 mm/min) is within the range of from 1 to 40 g/cm, preferably from 2 to 20 g/cm, and more preferably from 2 to 10 g/cm. If the peel strength is less than 1 g/cm, this is undesirable because, even though the support film (backing film) and the base film have been bonded together, the support film may tend to peel in the steps of producing the flexible transparent conductive film and flexible functional device. If on the other hand the peel strength is more than 40 g/cm, this is undesirable because the support film (backing film) can not easily be peeled from the base film and there may be high possibilities that, e.g., the step of peeling the support film from the flexible transparent conductive film may come poorly operable, any forcible peeling may cause elongation of the device and deterioration (such as cracking) of the transparent conductive layer and the weak pressure-sensitive adhesive layer may partly adhere to the base film surface.

Now, depending on the type of the flexible functional device, the device may be produced through the step of heat treatment (e.g., at approximately from 120° C. to 140° C.) for the flexible transparent conductive film. Accordingly, the above peel strength must be maintained also after the device has undergone the heat treatment step. For this end, the material for the weak pressure-sensitive adhesive layer is required to have heat resistance. Further, where the step of ultraviolet curing is employed when the flexible transparent conductive film is produced, the material for the weak pressure-sensitive adhesive layer is required to have resistance to ultraviolet light.

In the case when the flexible functional device is produced through the step of heat treatment for the flexible transparent conductive film, it is desirable that, before and after such a heat treatment step, the rates of dimensional changes of the flexible transparent conductive film in its machine direction (MD) and transverse direction (TD) are both 0.3% or less, preferably 0.15% or less, and more preferably 0.1% or less. Here, in plastic films, the rate of a dimensional change attended by heat treatment refers commonly to the degree (or factor) of shrinkage. In the above, it is not preferable that the rates of dimensional changes (degrees of shrinkage) of the flexible transparent conductive film in its machine direction (MD) and transverse direction (TD) are more than 0.3%. This is for the following reasons: Where the flexible transparent conductive film is used in, e.g., a flexible dispersion-type EL device, it follows that a phosphor layer, a dielectric layer, a back electrode layer and so forth are superposed in this order on the flexible transparent conductive film. In that case, for each layer to be formed, a layer forming paste is applied by pattern printing, followed by drying and then heat curing. Here, if the rates of dimensional changes (degrees of shrinkage) of the flexible transparent conductive film in its machine direction (MD) and transverse direction (TD) are more than 0.3%, the dimensional changes (shrinkage) may come about at every time each layer is subjected to heat curing treatment, to cause print deviations. This brings a possibility that the extent of such deviations may come beyond the tolerance limit in producing the dispersion-type EL device.

As methods for reducing the rates of dimensional changes, available are a method in which a low-heat shrinkage type base film is used which has previously been brought into heat shrinkage, a method in which a base film is used which has been backed with a low-heat shrinkage type support film (backing film), a method in which the above base film or base film having been backed with a support film is previously kept into heat shrinkage, and a method in which the whole flexible transparent conductive film is brought into heat shrinkage.

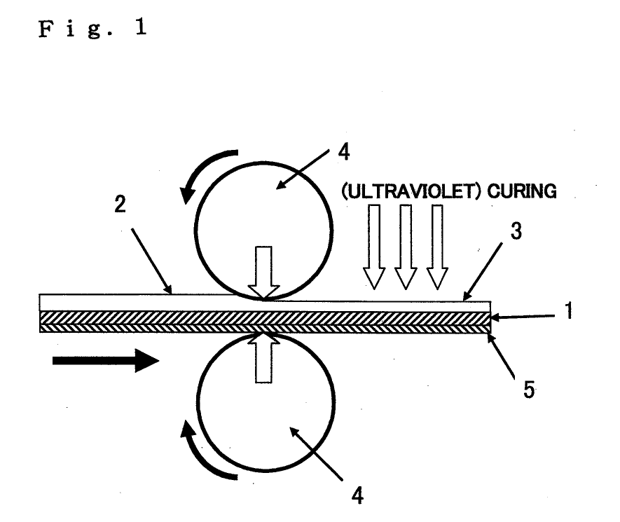

Next, in the present invention the transparent conductive layer may be formed in the following way. First, conductive fine oxide particles and a binder component which makes a binder matrix are dispersed in a solvent to prepare a transparent conductive layer forming coating fluid, and, with this coating fluid, the plastic film (the base film) 1 having on its one side a peelable backing film 5 and having been provided with gas barrier function as shown in FIG. 1 is coated thereon, followed by drying to form a coating layer 2. Thereafter, this coating layer 2 is subjected to compressing together with the base film 1 and the backing film 5 by means of steel rolls 4 or the like, and then the binder component of the coating layer 2 having been subjected to compressing is cured to form the transparent conductive layer 3. Note that FIG. 1 exemplarily illustrates a curing method by ultraviolet irradiation.

As methods for coating the base film with the transparent conductive layer forming coating fluid, any general-purpose methods may be used, including, but not limited to, screen printing, blade coating, wire bar coating, spray coating, roll coating, gravure coating and ink-jet printing.

The coating layer obtained by coating the base film with the transparent conductive layer forming coating fluid, followed by drying, is made up of conductive fine oxide particles and an uncured binder component, and hence the compressing thus carried out makes the conductive fine oxide particles be filled in the transparent conductive layer in a vastly higher density. This not only can make the light less scatter in the layer to make it improved in optical properties, but also can make the layer vastly improved in its electro-conductivity. As the compressing, the base film having been coated with the transparent conductive layer forming coating fluid, followed by drying, may be rolled by means of, e.g., metal rolls hard-plated with chromium. The metal rolls in such a case may be used under conditions of a rolling pressure of from 29.4 to 490 N/mm (from 30 to 500 kgf/cm), and more preferably from 98 to 294 N/mm (from 100 to 300 kgf/cm), as linear pressure. This is because, if it is done under conditions of a linear pressure of less than 29.4 N/mm (30 kgf/cm), the effect of improving the resistivity of the transparent conductive layer in virtue of the rolling may be insufficient, and on the other hand under conditions of a linear pressure of more than 490 N/mm (500 kgf/cm), the rolling may require large-scale installation, and at the same time the base film (the plastic film having been provided with gas barrier function) or the support film (backing film) may strain or the gas barrier layer may come broken to cause deterioration of the gas barrier function. That is, the present invention has been accomplished on the basis of a finding that, as long as the rolling making use of the metal rolls or the like is properly carried out, the transparency and electro-conductivity of the transparent conductive layer can be improved without involving any lowering of the gas barrier function, even if a compression stress is applied to the gas barrier layer of the base film.

Incidentally, rolling pressure per unit area (N/mm²) in the rolling making use of the metal rolls is the value found when the linear pressure is divided by the nip width (the width of a zone where the transparent conductive film is compressed by the metal rolls at the part of contact between the metal rolls and the transparent conductive film). The nip width, which depends on the metal roll diameter and linear pressure, may be approximately from 0.7 mm to 2 mm where the roll diameter is about 150 mm.

Now, in the present invention, a thin base film (plastic film having been provided with gas barrier function) having a thickness of approximately from 3 μm to 50 μm is used. However, in the case when this base film is backed with the support film (backing film) by the latter's lamination to the former, the base film can effectively be prevented from coming to strain or wrinkle, even when such a very thin base film is subjected to the rolling. Further, in the case of the rolling making use of the metal rolls hard-plated with chromium, the metal rolls are mirror-smooth rolls the surfaces of which have a very small unevenness, and hence the surface of the transparent conductive layer, obtained as a result of the rolling, can have a very smooth surface. This is because, even where any protrusions are present on the coating layer formed by coating with the transparent conductive layer forming coating fluid, such protrusions can physically be made smooth by the rolling making use of the metal rolls. Inasmuch as the surface of the transparent conductive layer has a good smoothness, there can be the effect of preventing electrodes from coming to short-circuit between them or devices from causing any defects, in the above various functional devices, as being very preferable.

The base film may be coated with the transparent conductive layer forming coating fluid by either of whole-area coating (solid printing) and pattern printing. The transparent conductive layer usually has a thickness of approximately from 0.5 μm to 1 μm [which corresponds to approximately from 92% to 96% in terms of the transmittance of the transparent conductive layer (the transmittance of only the transparent conductive layer not inclusive of the base film)], which is smaller than the thickness (3 to 50 μm) of the base film (the plastic film having been provided with gas barrier function), and hence the pressure at the time of the compressing can uniformly be applied even where the transparent conductive layer has any pattern because of the pattern printing.

The transparent conductive layer in the present invention is obtained by curing the binder component of the coating layer having been subjected to the compressing. It may be cured by a method selected appropriately from heat treatment (drying curing or heat curing), ultraviolet irradiation treatment (ultraviolet curing) and so forth, in accordance with the type of the transparent conductive layer forming coating fluid.

Next, the conductive fine oxide particles of the transparent conductive layer forming coating fluid used in the present invention may be those composed chiefly of at least one of indium oxide, tin oxide and zinc oxide, and may include, e.g., fine indium-tin oxide (ITO) particles, fine indium-zinc oxide (IZO) particles, fine indium-tungsten oxide (IWO) particles, fine indium-titanium oxide (ITiO) particles, fine indium-zirconium oxide (IZrO) particles, fine tin-antimony oxide (ATO) particles, fine fluoro-tin oxide (FTO) particles, fine aluminum-zinc oxide (AZO) particles and fine gallium-zinc oxide (GZO) particles, which may at least have transparency and electro-conductivity, and are by no means limited to these. In particular, however, fine indium-tin oxide (ITO) particles are preferred as having the highest properties.

The conductive fine oxide particles may preferably have an average particle diameter of from 1 nm to 500 nm, and more preferably from 5 nm to 100 nm. If they have an average particle diameter of less than 1 nm, the transparent conductive layer forming coating fluid may be prepared with difficulty and the resultant transparent conductive layer may have a high resistivity. If on the other hand they have an average particle diameter of more than 500 nm, the conductive fine oxide particles tend to settle to form sediment in the transparent conductive layer forming coating fluid. Hence, such particles may be not handled with ease, and at the same time may make it difficult to achieve a high transmittance and a low resistivity simultaneously in the transparent conductive layer. The average particle diameter of the conductive fine oxide particles shows the value observed on a transmission electron microscope (TEM).

The binder component in the transparent conductive layer forming coating fluid has the function to make the conductive fine oxide particles bind with one another to improve the electro-conductivity and strength of the layer, and the function to improve the adhesion between the underlying base film and the transparent conductive layer. It further has the function to provide the transparent conductive layer with solvent resistance so that the transparent conductive layer can be prevented from deteriorating because of an organic solvent contained in various printing pastes used when various functional films are formed by multi-layer printing or the like in the steps of producing the flexible functional devices. As the binder component, an organic binder and/or an inorganic binder may be used, which may appropriately be selected taking account of the base film to be coated with the transparent conductive layer forming coating fluid, layer-forming conditions for the transparent conductive layer, and so forth so as to satisfy the above functions.

As the organic binder, any thermoplastic resin such as acrylic resin or polyester resin may certainly be usable in some cases, but it is commonly preferable for the organic binder to have solvent resistance. For this end, the organic binder is required to be a cross-linkable resin, which may be selected from a thermosetting resin, a cold-curable resin, an ultraviolet curable resin and an electron beam curable resin. For example, as the thermosetting resin, it may include epoxy resin and fluorine resins; as the cold-curable resin, two-pack epoxy resin and urethane resin; as the ultraviolet curable resin, various oligomer-, monomer- or photoinitiator-containing resins; and as the electron beam curable resin, various oligomer- or monomer-containing resins. Examples are by no means limited to these resins.

The inorganic binder may include binders composed chiefly of silica sol, alumina sol, zirconia sol, titania sol or the like. For example, as the silica sol, usable are a polymer obtained by adding water or an acid catalyst to a tetraalkyl silicate to effect hydrolysis, and then making dehydropolycondensation proceed; and a polymer obtained using a commercially available tetraalkyl silicate solution the polymerization of which has been made to proceed to form a tetra- to pentamer, and by making its hydrolysis and dehydropolycondensation further proceed. However, if the dehydropolycondensation proceeds in excess, the solution may increase in viscosity to finally come to solidify. Hence, as to the degree of dehydropolycondensation, it is so controlled that the viscosity may be not more than the maximum viscosity at which the base film (the plastic film having been provided with gas barrier function) can be coated thereon with the coating fluid. However, there are no particular limitations on the degree of dehydropolycondensation as long as it is at the level not more than the above maximum viscosity. Taking account of film strength, weatherability and so forth, it may preferably be approximately from 500 to 50,000 in weight average molecular weight. Then, the resultant alkyl silicate hydrolyzed polymer product (the silica sol) substantially completely undergoes the dehydropolycondensation reaction (cross-linking reaction) at the time of heating carried out after the transparent conductive layer forming coating fluid has been coated and dried, to come into a hard silicate binder matrix (a binder matrix composed chiefly of silicon oxide).

The dehydropolycondensation reaction begins immediately after the film (coating layer) has been dried, and, upon lapse of time, comes to solidify so strongly that the conductive fine oxide particles can no longer move one another. Accordingly, in the case when the inorganic binder is used, it is desirable for the above compressing to be carried out as speedily as possible after the transparent conductive layer forming coating fluid has been coated and dried.

As the binder, an organic-inorganic hybrid binder may be used, which may include, e.g., a binder obtained by partially modifying the silica sol with an organic functional group, and a binder composed chiefly of a coupling agent of various types such as a silicon coupling agent. Also, a transparent conductive layer making use of the inorganic binder or organic-inorganic hybrid binder necessarily has a good solvent resistance, which binder, however, must appropriately be selected so as for the transparent conductive layer not to have a poor adhesion to the underlying base film or a poor flexibility.

In the transparent conductive layer forming coating fluid used in the present invention, the conductive fine oxide particles and the binder component may preferably be in a proportion of conductive fine oxide particles: binder component=85:15 to 97:3, and more preferably 87:13 to 95:5, in weight ratio, assuming that the specific gravity of the conductive fine oxide particles and that of the binder component are about 7.2 (specific gravity of ITO) and about 1.2 (specific gravity of a usual organic resin binder), respectively. The reason therefor is that, when in the present invention the rolling of the coating layer is carried out, the transparent conductive layer may come too high in resistivity if the binder component is in a larger proportion than 85:15, and if on the other hand the binder component is in a smaller proportion than 97:3, the transparent conductive layer may have a low strength and at the same time may have no sufficient adhesion to the underlying base film.

The transparent conductive layer forming coating fluid used in the present invention is prepared in the following way. First, the conductive fine oxide particles are mixed with a solvent and optionally with a dispersant, and thereafter dispersion treatment is carried out to obtain a dispersion of the conductive fine oxide particles. The dispersant may include various coupling agents such a silane coupling agent, various polymeric dispersants, and various surface-active agents of an anionic type, a nonionic type, a cationic type and so forth. Any of these dispersants may appropriately be selected in accordance with the type of the conductive fine oxide particles to be used and the manner of the dispersion treatment. Also, even without use of any dispersant at all, a good state of dispersion can be achieved in some cases, depending on how the combination of the conductive fine oxide particles and the solvent which are to be used is and how the manner of dispersion is. The use of the dispersant involves a possibility of making the film (transparent conductive layer) have poor resistivity and weatherability, and hence a transparent conductive layer forming coating fluid making use of no dispersant is most preferred. As the dispersion treatment, it may be carried out by a general-purpose method or means such as ultrasonic treatment, a homogenizer, a paint shaker or a bead mill.

To the resultant dispersion of conductive fine oxide particles, the binder component is added, and then componential adjustment may be made for the adjustment of conductive fine oxide particle concentration, solvent composition and so forth to obtain the transparent conductive layer forming coating fluid. Here, the binder component is added to the dispersion of conductive fine oxide particles. It, however, may be added before the step of dispersing the conductive fine oxide particles, without any particular limitations. The concentration of the conductive fine oxide particles may appropriately be set in accordance with the coating method to be employed.

As the solvent for the transparent conductive layer forming coating fluid used in the present invention, there are no particular limitations thereon, and it may appropriately be selected in accordance with the coating method, film-forming conditions and materials for the base film. It may include, but is not limited to, e.g., water; alcohol type solvents such as methanol (MA), ethanol (EA), 1-propanol (NPA), isopropanol (IPA), butanol, pentanol, benzyl alcohol and diacetone alcohol (DAA); ketone type solvents such as acetone, methyl ethyl ketone (MEK), methyl propyl ketone, methyl isobutyl ketone (MIBK), cyclohexanone and isophorone; ester type solvents such as ethyl acetate, butyl acetate, isobutyl acetate, amyl formate, isoamyl acetate, butyl propionate, isopropyl butyrate, ethyl butyrate, butyl butyrate, methyl lactate, ethyl lactate, methyl oxyacetate, ethyl oxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl acetoacetate, ethyl acetoacetate, methyl 2-oxobutanoate and ethyl 2-oxobutanoate; glycol derivatives such as ethylene glycol monomethyl ether (MCS), ethylene glycol monoethyl ether (ECS), ethylene glycol isopropyl ether (IPC), ethylene glycol monobutyl ether (BCS), ethylene glycol monoethyl ether acetate, ethylene glycol monobutyl ether acetate, propylene glycol methyl ether (PGM), propylene glycol ethyl ether (PE), propylene glycol methyl ether acetate (PGM-AC), propylene glycol ethyl ether acetate (PE-AC), diethylene glycol monomethyl ether, diethylene glycol monoethyl ether, diethylene glycol monobutyl ether, diethylene glycol monomethyl ether acetate, diethylene glycol monoethyl ether acetate, diethylene glycol monobutyl ether acetate, diethylene glycol dimethyl ether, diethylene glycol diethyl ether, diethylene glycol dibutyl ether, dipropylene glycol monomethyl ether, dipropylene glycol monoethyl ether, and dipropylene glycol monobutyl ether; benzene derivatives such as toluene, xylene, mesitylene and dodecylbenezene; and formamide (FA), N-methylformamide, dimethylformamide (DMF), dimethylacetamide, dimethyl sulfoxide (DMSO), N-methyl-2-pyrrolidone (NMP), γ-butyrolactone, ethylene glycol, diethylene glycol, propylene glycol, dipropylene glycol, 1,3-butylene glycol, pentamethylene glycol, 1,3-octylene glycol, tetrahydrofuran (THF), chloroform, mineral sprit, and terpineol.

The flexible functional device in which the flexible transparent conductive film of the present invention is to be used is described next. Such a flexible functional device may include, as mentioned previously, a liquid-crystal display device, an organic EL device, a dispersion-type inorganic EL device and an electronic paper device.

Here, the liquid-crystal display device is a non-luminescent electronic display device used widely in display of cellular telephones, PDAs (personal digital assistants), PCs (personal computers) and so forth, and includes a simple matrix type (passive matrix type) and an active matrix type. The active matrix type is advantageous in view of image quality and response speed. As basic structure, it is a structure in which a liquid crystal is held between transparent electrodes (to which the transparent conductive layer in the present invention corresponds) and liquid-crystal molecules are aligned by voltage drive to perform display. An actual device makes use of, in addition to the transparent electrodes, a color filter, a retardation film, a polarizing film and so forth which are formed in multi-layers.

Further, examples of another type of liquid-crystal display device also include a polymer dispersed liquid-crystal device (hereinafter simply “PDLC device”), a polymer network liquid-crystal device (hereinafter simply “PNLC device”), and the like, which are each exemplarily used as an optical shutter of a window or the like. The basic structure of each device is a structure in which a liquid crystal layer is held between electrodes (at least one of them is a transparent electrode to which the transparent conductive layer in the present invention corresponds) and liquid-crystal molecules are aligned by voltage drive to cause a change of external appearance of the liquid crystal layer between transparent and opaque as described above. However, unlike the above liquid-crystal display devices, an actual device of this type requires no retardation films, nor polarizing films, to provide a feature of simplified structure of the device. Here, the PDLC device has a structure of a polymeric resin matrix containing liquid crystals in microcapsule forms dispersed therein and the PNLC device has a structure of a meshed network resin filled with liquid crystals at mesh openings. Although the PDLC device is typically high in resin content ratio in the liquid crystal layer to require an AC drive voltage of several tens of volts or higher (about 80V, for example), the PNLC device, which is allowed to be low in resin content ratio of the liquid crystal layer, can be characterizedly driven by an AC voltage of about several volts to 15V.

In order to secure display stability of the liquid-crystal display device, it is necessary to prevent water vapor from entering the liquid crystal, where, e.g., a water vapor transmission rate of 0.01 g/m²/day or less is required.

The organic EL device is, different from the liquid-crystal display device, a self-luminescent device. It can achieve a high brightness by low-voltage drive, and hence it is expected as a display device for flat-panel display and so forth. It has a structure in which a hole injection layer composed of a conductive polymer such as a polythiophene derivative, an organic luminescent layer (a low-molecular luminescent layer formed by vacuum deposition or a high-molecular luminescent layer formed by coating), a cathode electrode layer [a metallic layer of magnesium (Mg), calcium (Ca), aluminum (Al) or the like, having a good performance of electron injection into the luminescent layer and a low work function] and a gas barrier coating layer (or sealing with metal or glass) are formed in this order on a transparent conductive layer serving as an anode electrode layer. The gas barrier coating layer is necessary to prevent the organic EL device from deteriorating and thus to have an oxygen barrier and a water vapor barrier, and, e.g., regarding water vapor, is required to have a very high gas barrier function of a water vapor transmission rate of about 10⁻⁵ g/m²/day or less.

The dispersion-type inorganic EL device is a self-luminescent device in which a strong AC electric field is applied to a layer which contains phosphor particles, to emit light. It has conventionally been used in, e.g., back lighting of liquid-crystal display in cellular telephones, remote controllers and so forth. As a new use in recent years, it is also set in portable information terminals such as cellular telephones, remote controllers, PDAs and laptop PCs, as a light source of key input component parts (keypads) of such various equipments. In the case when it is used in the keypads, the device is required to be made as thin as possible so that key-touch durability and a good click feeling in key operation can be secured. Such a device is basically so structured that at least a phosphor layer, a dielectric layer and a back electrode layer are formed in this order on the transparent conductive layer as a transparent electrode by screen printing or the like. It is common in actual devices that a collector electrode made of silver, an insulating protective layer and so forth are further formed.

The electronic paper device is a non-luminescent electronic display device, which does not emit light in itself, and has a memory effect that the display remains as it is even when the power supply is shut off. Thus, it is expected as a display device for displaying letters and characters. Its display system may include an electrophoretic display system, in which colored particles are made to move in a liquid held between electrodes; a twisting ball display system, in which particles having dichroism are rotated in the presence of an electric field to color them; a liquid-crystal display system, in which, e.g., a cholesteric liquid crystal is sandwiched between transparent electrodes to perform display; a powder-type display system, in which colored particles (a toner) or an electronic powder fluid (quick-response liquid powder; QR-LPD, Quick-Response Liquid Powder Display, Bridgestone Corp.) move(s) in the air to perform display; an electrochromic display system, in which colors are developed on the basis of electrochemical redox reaction; and an electrodeposition display system, in which a metal is deposited and dissolved by electrochemical redox and changes in color thereby caused are utilized to perform display. In the electronic paper devices of these various systems, in order to secure their display stability, it is necessary to prevent water vapor from entering the display layer, where, e.g., a water vapor transmission rate of from 0.01 to 0.1 g/m²/day is required, which depends on the systems.

The flexible functional device of any of the above liquid-crystal display device, organic EL device, dispersion-type inorganic EL device and electronic paper device can be obtained by forming each of the functional devices on the transparent conductive layer of the flexible transparent conductive film according to the present invention, and this enables achievement of the subjects of making devices thin-gauge, light-weight and flexible as required in the functional devices.

In the liquid-crystal display device, organic EL device, and electronic paper device each having a display function among the above flexible functional devices, the display system thereof may be either of the above simple matrix type (passive matrix type) or the active matrix type. For example, in case of the simple matrix type, it is enough that a functional layer (display layer) is held between two films provided with electrodes, each film having a line pattern electrode, such that the line pattern electrodes are orthogonalized to each other and the electrode surfaces face each other, and the flexible transparent conductive film of the present invention may be then used as at least one of the two film films provided with electrodes in a manner that the flexible transparent conductive film has a transparent conductive layer patterned into lines. In turn, in case of the active matrix type, it is enough that a functional layer (display layer) is held between: a transparent conductive film formed with a transparent conductive layer (common electrode) over a whole surface; and a backside film (back plane) formed with TFT's (thin film transistors) each connected to a scanning line and a signal line, and formed with pixel electrodes, for display-pixels, respectively; and the flexible transparent conductive film of the present invention may be then directly used as the common electrode side film, or may be used as the backside film by patterning the transparent conductive layer into pixel electrode shapes. It is preferable to use an organic TFT having a superior flexibility as compared to a silicon TFT, as the above TFT's. The organic TFT is superior to the silicon TFT in view of cost as well, because the former can be formed on a plastic film by coating (printing).

As described above, in the flexible functional device according to the present invention, such as the liquid-crystal display device, the organic EL device, the dispersion-type inorganic EL device or the electronic paper device, the flexible transparent conductive film having gas barrier function in spite of use of a thin base film is used as a transparent electrode material. Hence, it has a superior flexibility, and, e.g., this makes it easy to set it in various thin-gauge equipments including cards and so forth, and further can contribute to the materialization of more thin-gauge equipments for such equipments.

The present invention is described below in greater detail by giving Examples. The present invention is by no means limited to the technical subject matter in these Examples.

### Example 1

In a mixture of 24 g of methyl isobutyl ketone (MIBK) and 36 g of cyclohexanone as solvents, 36 g of fine ITO particles of 0.03 μm in average particle diameter (available from Sumitomo Metal Mining Co., Ltd.; trade name: SUFP-HX) were mixed, and these were subjected to dispersion treatment. Thereafter, to the dispersion obtained, 3.8 g of a urethane acrylate type ultraviolet-curable resin binder and 0.2 g of a photoinitiator (available from Ciba Japan K.K.; trade name: DAROCURE 1173) were added, and these were well stirred to prepare a transparent conductive layer forming coating fluid (fluid A) in which fine ITO particles of 125 nm in average dispersed-particle diameter stood dispersed.

Next, before the flexible transparent conductive film was produced, a plastic film of about 13 μm in thickness [available from Toppan Printing Co., Ltd.; trade name: GX-P-F Film (hereinafter simply “GX Film”); GX Film, constituted of: PET film (thickness: 12 μm)/vapor-deposited alumina gas barrier layer (thickness: 10 to several tens nm)/silicate-polyvinyl alcohol hybrid coating layer (coated film, thickness: 0.2 to 0.6 μm); water vapor transmission rate of GX Film: 0.04 g/m²/day; visible-light transmittance: 88.5%; haze value: 2.3%], having been provided with gas barrier function, was used as a base film of the flexible transparent conductive film. To this base film and on its side on which the above gas barrier layer (constituted of the alumina gas barrier layer and the silicate-polyvinyl alcohol hybrid coating layer) was formed, a support film (backing film) made up of a PET film of 100 μm in thickness was laminated via a heat-resistant silicone weak pressure-sensitive adhesive layer.

Next, this base film was, on its side opposite to the support film (i.e., on the PET film surface on which the gas barrier layer was not formed), subjected to corona discharge treatment, and thereafter coated on the surface thus treated, with the transparent conductive layer forming coating fluid (fluid A) by wire bar coating (wire diameter: 0.10 mm), followed by drying at 60° C. for 1 minute. Thereafter, this was subjected to rolling (linear pressure: 200 kgf/cm=196 N/mm; nip width: 0.9 mm) by means of hard-chromium-plated metal rolls of 100 mm each in diameter. Further, the binder component was cured by using a high-pressure mercury lamp (in an atmosphere of nitrogen, and at 100 mW/cm² for 2 seconds) to form on the base film a transparent conductive layer (layer thickness: about 0.5 μm) made up of fine ITO particles filled densely therein and a binder matrix. Thus, a flexible transparent conductive film according to Example 1 was obtained (thickness of the base film with transparent conductive layer: about 13.5 μm).

The flexible transparent conductive film according to Example 1 is constituted of “support film (backing film)”/“base film made up of GX Film”/“transparent conductive layer”. The base film made up of GX Film has a thickness of as very small as about 13 μm as noted above and is very flexible, and the constituent materials of the GX Film having been provided with gas barrier function are so highly transparent that the visible-light absorption can be very small which comes from the presence of the base film in the flexible transparent conductive film according to Example 1.

Evaluation was conducted for an adhesion between the base film and transparent conductive layer of the flexible transparent conductive film constituted of “support film (backing film)”/“base film made up of GX Film”/“transparent conductive layer” by the tape peel test (cross-cut test) according to JIS K 5600-5-6, and the adhesion was excellent to be 25/25 (the number of unpeeled squares/the total number of squares [5×5=25]). Incidentally, since the base film had a thickness of as thin as about 13 μm, even the base film would be cut together with the transparent conductive layer if the latter was directly cross-cut. Thus, the evaluation was conducted by once peeling the base film formed with the transparent conductive layer from the support film (backing film), and then laminating the base film to a PET film having a thickness of 100 μm via epoxy-based adhesive.

The water vapor transmission rate of the flexible transparent conductive film according to Example 1 was measured whole together with the support film to find that its water vapor transmission rate was 0.04 g/m²/day, thus it was ascertained that the water vapor transmission rate did not come to deteriorate because of the corona discharge treatment, the rolling and so forth carried out in the course of forming the transparent conductive layer. Here, the support film is constituted of the PET film having no gas barrier function, and its water vapor transmission rate is as many as at least tens of times higher than the water vapor transmission rate of the GX Film having been provided with gas barrier function. Hence, the water vapor transmission rate measured whole on the flexible transparent conductive film together with the support film may be considered to be substantially equal to the water vapor transmission rate of the “GX Film on which the transparent conductive layer has been formed” obtained by peeling the support film from the flexible transparent conductive film. A course of measurement of the water vapor transmission rate is made by the Mocon method according to JIS K 7129 B (test atmosphere: 40° C., 95% RH).

The GX Film had an oxygen barrier function as well in addition to the water vapor barrier, and had an oxygen transmission rate of about 0.2 cc/m²/day/atm (test atmosphere: 30° C.×70% RH), so that the flexible transparent conductive film according to Example 1 also had the same oxygen barrier function.

The flexible transparent conductive film according to Example 1 also had a peel strength of 5.0 g/cm at its part between the “support film (backing film)” and the “base film made up of GX Film”. Here, the peel strength is 180° peel strength [the strength measured when the base film is peeled at an angle of 180° at a tensile speed of 300 mm/min].

The transparent conductive layer had film characteristics of a visible-light transmittance of 95.3%, a haze value of 3.7% and a surface resistivity of 1,000 Ω/square. As to the surface resistivity, it may be influenced by the ultraviolet irradiation when the binder component is cured, to tend to temporarily lower immediately after the curing. Hence, it is measured 1 day after the transparent conductive layer has been formed. Also, the transmittance and haze value of the transparent conductive layer are values of only the transparent conductive layer, which are found according to the following calculating expressions 1 and 2, respectively.

Transmittance (%) of transparent conductive layer=[(transmittance measured whole on transparent conductive layer together with base film backed with support film)/(transmittance of base film backed with support film)]×100. Calculating expression 1:

Haze value (%) of transparent conductive layer=(haze value measured whole on transparent conductive layer together with base film backed with support film)−(haze value of base film backed with support film). Calculating expression 2:

The surface resistivity of the transparent conductive layer was measured with a surface resistance meter LORESTA AP MCP-T400 (trade name), manufactured by Mitsubishi Chemical Corporation. The haze value and visible-light transmittance were measured with a haze meter NDH 5000 (trade name), manufactured by Nippon Denshoku Industries Co., Ltd., and according to JIS K 7136 (haze value) and JIS K7361-1 (transmittance).

Next, on the transparent conductive layer (first transparent conductive layer) of the flexible transparent conductive film according to Example 1 (which film is herein called a “first transparent conductive film”; the base film and transparent conductive layer thereof are also called a “first base film” and a “first transparent conductive layer”, respectively), a display layer (layer thickness: 40 μm) of an electrophoretic system was formed which was made up of microcapsules containing white fine particles and black fine particles. Further, to the display layer thus formed, another flexible transparent conductive film according to Example 1 (which is herein called a “second transparent conductive film”; the base film and transparent conductive layer thereof are also called a “second base film” and a “second transparent conductive layer”, respectively) was laminated with its transparent conductive layer (second transparent conductive layer) faced the display layer.

Next, at one ends of the respective transparent conductive layers (first transparent conductive layer and second transparent conductive layer) of the first transparent conductive film and second transparent conductive film provided respectively on the both sides of the middle-lying display layer between them, Ag lead wires for applying voltage were respectively formed by using a silver conductive paste. Thereafter, the support films (backing films) of the first transparent conductive film and second transparent conductive film were respectively peeled to obtain a flexible functional device (electronic paper device) according to Example 1 (thickness of the device: about 67 μm).

In the electronic paper device, taking account of, e.g., an improvement in contrast, it is essentially desirable to use a transparent conductive layer in one electrode and to use in the other electrode a black conductive film such as a carbon paste coated film. In such a case, the base film on which the black conductive film is to be formed by coating need not to have any transparency, and hence a metal foil of stainless steel or the like or a plastic film deposited with a metal such as aluminum may be used as the base film. In each Example and Comparative Example of the present invention, however, transparent conductive layers are used in both the two electrodes which apply voltage to the electronic paper device.

Thus, the above about 67 μm thick flexible functional device (electronic paper device) according to Example 1 is constituted of “about 13 μm thick first base film having gas barrier function”/“about 0.5 μm thick first transparent conductive layer”/“display layer (thickness: 40 μm)”/“about 0.5 μm thick second transparent conductive layer”/“about 13 μm thick second base film having gas barrier function”.

In this flexible functional device (electronic paper device), in order to prevent it, e.g., from short-circuiting between electrodes and from causing an electric shock, insulating protective layers making use of an insulating paste are formed on the transparent conductive layers (first transparent conductive layer and second transparent conductive layer) and on the Ag lead wires for applying voltage. Details thereof, however, are omitted as being not components concerned with the essence of the present invention. Also, in the steps of producing the flexible functional device according to Example 1, the respective support films (backing films) were peeled with ease at their interfaces with the base films. This is because the flexible transparent conductive film according to Example 1 had peel strength of 5.0 g/cm as noted above, at its part between the “support film (backing film)” and the “base film made up of GX Film”.

Then, a DC voltage of 10 V was applied across the Ag lead wires for applying voltage, of the flexible functional device (electronic paper device) according to Example 1, and the polarity was repeatedly reversed, whereupon white and black were alternately repeatedly displayed.

### Example 2

Before the flexible transparent conductive film is produced, two sheets of the same plastic film of about 13 μm in thickness (available from Toppan Printing Co., Ltd.; trade name: GX Film) as that used in Example 1 were laminated to each other on their gas barrier layer (made up of an alumina gas barrier layer and a silicate-polyvinyl alcohol hybrid coating layer) sides, with an adhesive to produce a gas barrier function reinforced film [film constituted of: PET film (thickness: 12 μm)/vapor-deposited alumina gas barrier layer (thickness: 10 to several tens nm)/silicate-polyvinyl alcohol hybrid coating layer (coated film, thickness: 0.2 to 0.6 μm)/adhesive layer (about 8 μm thick)/silicate-polyvinyl alcohol hybrid coating layer (coated film, thickness: 0.2 to 0.6 μm)/vapor-deposited alumina gas barrier layer (thickness: 10 to several tens nm)/PET film (thickness: 12 μm); water vapor transmission rate of the film: less than 0.01 g/m²/day, i.e., vapor transmission rate of the film<0.01 g/m²/day; visible-light transmittance: 87.2%; haze value: 4.5%]. This gas barrier function reinforced film was used as a base film of the flexible transparent conductive film. To this base film (gas barrier function reinforced film) and on its one PET film side, a support film (backing film) made up of a PET film of 125 μm in thickness was laminated via a heat-resistant silicone weak pressure-sensitive adhesive layer.

Next, the subsequent procedure of Example 1 was repeated except that this base film was, on its side opposite to the support film (i.e., on the PET film surface on one side), subjected to adhesion-promoting treatment by corona discharging, and thereafter coated on the surface thus treated, with the transparent conductive layer forming coating fluid (fluid A) by wire bar coating to form on the base film a transparent conductive layer (layer thickness: about 0.5 μm) made up of fine ITO particles filled densely therein and a binder matrix. Thus, a flexible transparent conductive film according to Example 2 was obtained (thickness of the base film with transparent conductive layer: about 34.5 μm).

The flexible transparent conductive film according to Example 2 is constituted of “support film (backing film)”/“base film formed by lamination of two sheets of GX Film”/“transparent conductive layer”. Thus, the base film made up of two sheets of GX Film has a thickness of as very small as about 34 μm as noted above and is very flexible, and the constituent materials of the gas barrier function reinforced film formed by lamination of two sheets of GX Film are so highly transparent that the visible-light absorption can be very small which comes from the presence of the base film in the flexible transparent conductive film according to Example 2.

Evaluation was conducted for an adhesion between the base film and transparent conductive layer of the flexible transparent conductive film constituted of “support film (backing film)”/“base film made up of laminated two GX Films”/“transparent conductive layer” in the same manner as Example 1, and the adhesion was excellent to be 25/25 (the number of unpeeled squares/the total number of squares [5×5=25]).

The water vapor transmission rate of the flexible transparent conductive film according to Example 2 was measured whole together with the support film to find that its water vapor transmission rate was less than 0.01 g/m²/day, thus it was ascertained that the water vapor transmission rate did not come to deteriorate because of the corona discharge treatment, the rolling and so forth carried out in the course of forming the transparent conductive layer. Here, the support film is constituted of the PET film having no gas barrier function, and its water vapor transmission rate is as many as at least tens of times higher than the water vapor transmission rate of the base film formed by lamination of two sheets of GX Film. Hence, the water vapor transmission rate measured whole on the flexible transparent conductive film together with the support film may be considered to be substantially equal to the water vapor transmission rate of the “base film on which the transparent conductive layer has been formed and made up of two sheets of GX Film” obtained by peeling the support film from the flexible transparent conductive film.

The gas barrier function reinforced film made of laminated two GX Films had an oxygen barrier function in addition to the water vapor barrier, and had an oxygen transmission rate<0.1 cc/m²/day/atm (test atmosphere: 30° C.×70% RH), so that the flexible transparent conductive film according to Example 2 also had the same oxygen barrier function.

The flexible transparent conductive film according to Example 2 also had a peel strength of 4.0 g/cm at its part between the “support film (backing film)” and the “base film formed by lamination of two sheets of GX Film”. Here, the peel strength is the 180° peel strength [the strength measured when the base film is peeled at an angle of 180° at a tensile speed of 300 mm/min] like that in Example 1.

The transparent conductive layer had film characteristics of a visible-light transmittance of 95.1%, a haze value of 3.5% and a surface resistivity of 1,050 Ω/square. As to the surface resistivity, it may be influenced by the ultraviolet irradiation when the binder component is cured, to tend to temporarily lower immediately after the curing. Hence, it is measured 1 day after the transparent conductive layer has been formed. Also, the transmittance and haze value of the transparent conductive layer are values of only the transparent conductive layer, which, like Example 1, are found according to the above calculating expressions 1 and 2, respectively. The surface resistivity of the transparent conductive layer was also measured in the same way as in Example 1.

Next, using the flexible transparent conductive film according to Example 2, the subsequent procedure of Example 1 was substantially repeated to obtain a flexible functional device (electronic paper device) according to Example 2 (thickness of the device: about 109 μm). This about 109 μm thick flexible functional device (electronic paper device) according to Example 2 is constituted of “about 34 μm thick first base film having gas barrier function”/“about 0.5 μm thick first transparent conductive layer”/“display layer (thickness: 40 μm)”/“about 0.5 μm thick second transparent conductive layer”/“about 34 μm thick second base film having gas barrier function”. Also, in the steps of producing the flexible functional device according to Example 2 as well, the respective support films (backing films) were peeled with ease at their interfaces with the base films.

Then, a DC voltage of 10 V was applied across the Ag lead wires for applying voltage, of the flexible functional device (electronic paper device) according to Example 2, and the polarity was repeatedly reversed, whereupon white and black were alternately repeatedly displayed.

### Example 3

In a mixture of 24 g of methyl isobutyl ketone (MIBK) and 36 g of cyclohexanone as solvents, 36 g of fine ITO particles of 0.03 μm in average particle diameter (available from Sumitomo Metal Mining Co., Ltd.; trade name: SUFP-HX) were mixed, and these were subjected to dispersion treatment. Thereafter, to the dispersion obtained, 4.0 g of a liquid thermosetting epoxy resin binder was added, and these were well stirred to prepare a transparent conductive layer forming coating fluid (fluid B) in which fine ITO particles of 130 nm in average dispersed-particle diameter stood dispersed.

Next, before the flexible transparent conductive film was produced, a plastic film of about 13 μm in thickness [available from Dai Nippon Printing Co., Ltd.; trade name: IB-PET-PXB Film (hereinafter simply “IB Film”); IB Film, constituted of: PET film (thickness: 12 μm)/vapor-deposited alumina gas barrier layer (thickness: 10 to several tens nm)/silicate-polyvinyl alcohol hybrid coating layer (coated film, thickness: 0.2 to 0.6 μm); water vapor transmission rate of IB Film: 0.08 g/m²/day; visible-light transmittance: 88.5%; haze value: 2.1%], having been provided with gas barrier function, was used as a base film of the flexible transparent conductive film. To this base film and on its PET film side on which the above gas barrier layer (constituted of the alumina gas barrier layer and the silicate-polyvinyl alcohol hybrid coating layer) was not formed, a support film (backing film) made up of a PET film of 100 μm in thickness was laminated via a heat-resistant silicone weak pressure-sensitive adhesive layer.

Next, this base film was, on its side opposite to the support film (i.e., on the surface on which the gas barrier layer was formed), coated with the transparent conductive layer forming coating fluid (fluid B) by wire bar coating (wire diameter: 0.15 mm), followed by drying at 60° C. for 1 minute. Thereafter, this was subjected to rolling (linear pressure: 200 kgf/cm=196 N/mm; nip width: 0.9 mm) by means of hard-chromium-plated metal rolls of 100 mm each in diameter. Further, the binder component was cured (cross-linked) by heating at 100° C. for 20 minutes to form on the base film a transparent conductive layer (layer thickness: about 1.0 μm) made up of fine ITO particles filled densely therein and a binder matrix. Thus, a flexible transparent conductive film according to Example 3 was obtained (thickness of the base film with transparent conductive layer: about 14 μm).

The flexible transparent conductive film according to Example 3 is constituted of “support film (backing film)”/“base film made up of IB Film”/“transparent conductive layer”. Thus, the base film made up of IB Film has a thickness of as very small as about 13 μm as noted above and is very flexible, and the constituent materials of the IB Film having been provided with gas barrier function are so highly transparent that the visible-light absorption can be very small which comes from the presence of the base film in the flexible transparent conductive film according to Example 3.

Evaluation was conducted for an adhesion between the base film and transparent conductive layer of the flexible transparent conductive film constituted of “support film (backing film)”/“base film made up of IB Film”/“transparent conductive layer” in the same manner as Example 1, and the adhesion was excellent to be 25/25 (the number of unpeeled squares/the total number of squares [5×5=25]).

The water vapor transmission rate of the flexible transparent conductive film according to Example 3 was measured whole together with the support film to find that its water vapor transmission rate was 0.08 g/m²/day, thus it was ascertained that the water vapor transmission rate did not come to deteriorate because of the rolling and so forth carried out in the course of forming the transparent conductive layer. Here, the support film is constituted of the PET film having no gas barrier function, and its water vapor transmission rate is as many as at least tens of times higher than the water vapor transmission rate of the IB Film having been provided with gas barrier function. Hence, the water vapor transmission rate measured whole on the flexible transparent conductive film together with the support film may be considered to be substantially equal to the water vapor transmission rate of the “IB Film on which the transparent conductive layer has been formed” obtained by peeling the support film from the flexible transparent conductive film.

The IB Film had an oxygen barrier function as well in addition to the water vapor barrier, and had an oxygen transmission rate of about 0.1 cc/m²/day/atm (test atmosphere: 23° C.×90% RH), so that the flexible transparent conductive film according to Example 3 also had the same oxygen barrier function.

The flexible transparent conductive film according to Example 3 also had a peel strength of 4.0 g/cm at its part between the “support film (backing film)” and the “base film made up of IB Film”. Here, the peel strength is the 180° peel strength like that in Examples 1 and 2.

The transparent conductive layer had film characteristics of a visible-light transmittance of 91.0%, a haze value of 4.4% and a surface resistivity of 650 Ω/square. The transmittance and haze value of the transparent conductive layer are values of only the transparent conductive layer, which, like Example 1, are found according to the above calculating expressions 1 and 2, respectively. The surface resistivity of the transparent conductive layer was also measured in the same way as in Example 1.

Next, using the flexible transparent conductive film according to Example 3, the subsequent procedure of Example 1 was substantially repeated to obtain a flexible functional device (electronic paper device) according to Example 3 (thickness of the device: about 68 μm). This about 68 μm thick flexible functional device (electronic paper device) according to Example 3 is constituted of “about 13 μm thick first base film having gas barrier function”/“about 1.0 μm thick first transparent conductive layer”/“display layer (thickness: 40 μm)”/“about 1.0 μm thick second transparent conductive layer”/“about 13 μm thick second base film having gas barrier function”. Also, in the steps of producing the flexible functional device according to Example 3 as well, the respective support films (backing films) were peeled with ease at their interfaces with the base films.

Then, a DC voltage of 10 V was applied across the Ag lead wires for applying voltage, of the flexible functional device (electronic paper device) according to Example 3, and the polarity was repeatedly reversed, whereupon white and black were alternately repeatedly displayed.

### Example 4

A polymer network liquid crystal (PNLC) comprising an ultraviolet curable resin and a liquid crystal was held between a transparent conductive layer (first transparent conductive layer) of the flexible transparent conductive film according to Example 1 (which film is herein called a “first transparent conductive film”; the base film and transparent conductive layer thereof are also called a “first base film” and a “first transparent conductive layer”, respectively), and a transparent conductive layer (second transparent conductive layer) of another flexible transparent conductive film according to Example 1 (which is herein called a “second transparent conductive film”; the base film and transparent conductive layer thereof are also called a “second base film” and a “second transparent conductive layer”, respectively); and thereafter the ultraviolet curable resin was cured by ultraviolet irradiation, to form a liquid crystal layer (layer thickness: about 10 μm).

Next, at one ends of the respective transparent conductive layers (first transparent conductive layer and second transparent conductive layer) of the first transparent conductive film and second transparent conductive film provided respectively on the both sides of the middle-lying liquid crystal layer between them, Ag lead wires for applying voltage were respectively formed by using a silver conductive paste. Thereafter, the support films (backing films) of the first transparent conductive film and second transparent conductive film were respectively peeled to obtain a flexible functional device (PNLC device) according to Example 4 (thickness of the device: about 37 μm).

Thus, the above about 37 μm thick flexible functional device (PNLC device) according to Example 4 is constituted of “about 13 μm thick first base film having been provided with gas barrier function”/“about 0.5 μm thick first transparent conductive layer”/“liquid crystal layer (thickness: about 10 μm)”/“about 0.5 μm thick second transparent conductive layer”/“about 13 μm thick second base film having been provided with gas barrier function”.

In this flexible functional device (PNLC device), in order to prevent it, e.g., from short-circuiting between electrodes and from causing an electric shock, insulating protective layers making use of an insulating paste are formed on the transparent conductive layers (first transparent conductive layer and second transparent conductive layer) and on the Ag lead wires for applying voltage. Details thereof, however, are omitted as being not components concerned with the essence of the present invention. Also, in the steps of producing the flexible functional device according to Example 4, the respective support films (backing films) were peeled with ease at their interfaces with the base films. This is because the flexible transparent conductive film according to Example 4 had peel strength of 5.0 g/cm as noted above, at its part between the “support film (backing film)” and the “base film made up of GX Film”.

Then, an AC voltage of 15 V was repeatedly turned ON and OFF across the Ag lead wires for applying voltage, of the flexible functional device (PNLC device) according to Example 4, and the external appearance change between transparent (ON)/opaque (OFF) was repeated (that is, an optical shutter function was ascertained).

The flexible functional device (PNLC device) according to Example 4 was extremely thin to have a total thickness of about 37 μm, and was extremely excellent in flexibility.

### Comparative Example 1

A PET film of 25 μm in thickness was used as a base film of a flexible transparent conductive film according to Comparative Example 1. This base film was coated thereon with the same transparent conductive layer forming coating fluid (fluid A) as that used in Example 1, by wire bar coating (wire diameter: 0.10 mm), followed by drying at 60° C. for 1 minute. Thereafter, this was subjected to rolling (linear pressure: 200 kgf/cm=196 N/mm; nip width: 0.9 mm) by means of hard-chromium-plated metal rolls of 100 mm in diameter. Further, the binder component was cured by using a high-pressure mercury lamp (in an atmosphere of nitrogen, and at 100 mW/cm² for 2 seconds) to form on the base film a transparent conductive layer (layer thickness: about 0.5 μm) made up of fine ITO particles filled densely therein and a binder matrix.

Next, to the above base film and on its side on which the transparent conductive layer was not formed, a plastic film of about 13 μm in thickness [available from Toppan Printing Co., Ltd.; trade name: GX Film; GX Film, constituted of: PET film (thickness: 12 μm)/vapor-deposited alumina gas barrier layer (thickness: 10 to several tens nm)/silicate-polyvinyl alcohol hybrid coating layer (coated film, thickness: 0.2 to 0.6 μm); water vapor transmission rate of GX Film: 0.05 g/m²/day; visible-light transmittance: 88.5%; haze value: 2.3%], having been provided with gas barrier function, was laminated via an adhesive layer (thickness: about 20 μm) to obtain a flexible transparent conductive film according to Comparative Example 1 (thickness of the base film with transparent conductive layer: 58.5 μm).

The flexible transparent conductive film according to Comparative Example 1 is, as described above, constituted of “about 13 μm thick plastic film (GX Film) having been provided with gas barrier function”/“about 20 μm thick adhesive layer”/“base film made up of about 25 μm thick PET film”/“about 0.5 μm thick transparent conductive layer”. It had a total thickness of 58.5 μm, and its flexibility was inferior to that of the flexible transparent conductive film according to Example 1, having a total thickness of 13.5 μm. The constituent materials of the base film made up of PET film and those of the adhesive layer, GX Film and so forth are so highly transparent that the visible-light absorption can be very small which comes from the presence of the base film, adhesive layer, GX Film and so forth in the flexible transparent conductive film according to Comparative Example 1.

Evaluation was conducted for an adhesion between the base film and transparent conductive layer of the flexible transparent conductive film constituted of “GX Film”/“adhesive layer”/“base film made up of PET film”/“transparent conductive layer” in the same manner as Example 1, and the adhesion was excellent to be 25/25 (the number of unpeeled squares/the total number of squares [5×5=25]).

The transparent conductive layer had film characteristics of a visible-light transmittance of 95.0%, a haze value of 3.8% and a surface resistivity of 1,000 Ω/square. As to the surface resistivity, it may be influenced by the ultraviolet irradiation when the binder component is cured, to tend to temporarily lower immediately after the curing. Hence, it is measured 1 day after the transparent conductive layer has been formed. Also, the transmittance and haze value of the transparent conductive layer are values of only the transparent conductive layer like that in Example 1, which are found according to the following calculating expressions 3 and 4, respectively.

Transmittance (%) of transparent conductive layer=[(transmittance measured whole on transparent conductive layer together with base film with GX Film laminated thereto)/(transmittance of base film with GX Film laminated thereto)]×100. Calculating expression 3:

Haze value (%) of transparent conductive layer=(haze value measured whole on transparent conductive layer together with base film with GX Film laminated thereto)−(haze value of base film with GX Film laminated thereto). Calculating expression 4:

The surface resistivity of the transparent conductive layer was, like that in Example 1, measured with a surface resistance meter LORESTA AP MCP-T400, manufactured by Mitsubishi Chemical Corporation. The haze value and visible-light transmittance were measured with a haze meter NDH 5000, manufactured by Nippon Denshoku Industries Co., Ltd., and according to JIS K 7136.

Next, using the flexible transparent conductive film according to Comparative Example 1, the subsequent procedure of Example 1 was substantially repeated to obtain a flexible functional device (electronic paper device) according to Comparative Example 1.

More specifically, on the transparent conductive layer (first transparent conductive layer) of the flexible transparent conductive film according to Comparative Example 1 (which film is herein called a “first transparent conductive film”; the base film and transparent conductive layer thereof are also called a “first base film” and a “first transparent conductive layer”, respectively), a display layer (layer thickness: 40 μm) of an electrophoretic system was formed which was made up of microcapsules containing white fine particles and black fine particles. Further, to the display layer thus formed, another flexible transparent conductive film according to Comparative Example 1 (which is herein called a “second transparent conductive film”; the base film and transparent conductive layer thereof are also called a “second base film” and a “second transparent conductive layer”, respectively) was laminated with its transparent conductive layer (second transparent conductive layer) faced the display layer.

Next, at one ends of the respective transparent conductive layers (first transparent conductive layer and second transparent conductive layer) of the first transparent conductive film and second transparent conductive film provided respectively on the both sides of the middle-lying display layer between them, Ag lead wires for applying voltage were respectively formed by using a silver conductive paste, to obtain the flexible functional device (electronic paper device) according to Comparative Example 1 (thickness of the device: about 157 μm).

Thus, the above about 157 μm thick flexible functional device (electronic paper device) according to Comparative Example 1 is constituted of “about 13 μm thick GX Film having been provided with gas barrier function”/“about 20 μm thick adhesive layer”/“first base film made up of about 25 μm thick PET film”/“about 0.5 μm thick first transparent conductive layer”/“display layer (thickness: 40 μm)”/“about 0.5 μm thick second transparent conductive layer”/“second base film made up of about 25 μm thick PET film”/“about 20 μm thick adhesive layer”/“about 13 μm thick GX Film having been provided with gas barrier function”. Its flexibility was inferior to that of each flexible functional device (electronic paper device) according to Example 1, having a total thickness of about 67 μm, and according to Example 3, having a total thickness of about 68 μm.

Then, like Example 1, a DC voltage of 10 V was applied across the Ag lead wires for applying voltage, of the flexible functional device (electronic paper device) according to Comparative Example 1, and the polarity was repeatedly reversed, whereupon white and black were alternately repeatedly displayed.

### Comparative Example 2

In the same transparent conductive film as that in Comparative Example 1, to the base film and on its side on which the transparent conductive layer was not formed, the same gas barrier function reinforced film (thickness: about 34 μm) formed by laminating GX Films to each other with an adhesive was laminated via an adhesive layer (thickness of about 20 μm) to obtain a flexible transparent conductive film according to Comparative Example 2 (thickness of the base film with transparent conductive layer: 79.5 μm).

The flexible transparent conductive film according to Comparative Example 2 is, as described above, constituted of “about 34 μm thick gas barrier function reinforced film (GX Film/adhesive layer/GX Film)”/“about 20 μm thick adhesive layer”/“base film made up of about 25 μm thick PET film”/“about 0.5 μm thick transparent conductive layer”. It had a total thickness of 79.5 μm, and its flexibility was inferior to that of the flexible transparent conductive film (the base film with transparent conductive layer) according to Example 2, having a total thickness of 34.5 μm. The constituent materials of the base film made up of PET film and those of the adhesive layer, GX Film and so forth are so highly transparent that the visible-light absorption can be very small which comes from the presence of the base film, adhesive layer, GX Film and so forth in the flexible transparent conductive film according to Comparative Example 2.

Evaluation was conducted for an adhesion between the base film and transparent conductive layer of the flexible transparent conductive film constituted of “film made up of laminated two GX Films”/“adhesive layer”/“base film made up of PET film”/“transparent conductive layer” in the same manner as Example 1, and the adhesion was excellent to be 25/25 (the number of unpeeled squares/the total number of squares [5×5=25]).

Next, using the flexible transparent conductive film according to Comparative Example 2, the subsequent procedure of Example 1 was substantially repeated to obtain a flexible functional device (electronic paper device) (thickness of the device: about 199 μm) according to Comparative Example 2. Here, this about 199 μm thick flexible functional device (electronic paper device) according to Comparative Example 2 is constituted of “about 34 μm thick gas barrier function reinforced film (GX Film/adhesive layer/GX Film)”/“about 20 μm thick adhesive layer”/“first base film made up of about 25 μm thick PET film”/“about 0.5 μm thick first transparent conductive layer”/“display layer (thickness: 40 μm)”/“about 0.5 μm thick second transparent conductive layer”/“second base film made up of about 25 μm thick PET film”/“about 20 μm thick adhesive layer”/“about 34 μm thick gas barrier function reinforced film (GX Film/adhesive layer/GX Film)”. Its flexibility was inferior to that of the flexible functional device (electronic paper device) according to Example 2, having a total thickness of about 109 μm.

Then, like Example 1, a DC voltage of 10 V was applied across the Ag lead wires for applying voltage, of the flexible functional device (electronic paper device) according to Comparative Example 2, and the polarity was repeatedly reversed, whereupon white and black were alternately repeatedly displayed.

### Comparative Example 3

The procedure of Example 1 was repeated except that the support film (backing film) was not laminated to the base film of Example 1 made up of the plastic film (GX Film) of about 13 μm in thickness, having been provided with gas barrier function, to obtain a flexible transparent conductive film (thickness of the base film with transparent conductive layer: about 13.5 μm) according to Comparative Example 3 including a transparent conductive layer (layer thickness: about 0.5 μm) made up of fine ITO particles filled densely therein and a binder matrix, on the base film.

Although the flexible transparent conductive film according to Comparative Example 3 was constituted of “base film made up of GX Film”/“transparent conductive layer”, the base film made up of the GX Film had a thickness of as small as about 13 μm and was extremely flexible, so that it was extremely difficult to uniformly apply rolling to the flexible transparent conductive film. Further, since defects such as “wrinkles” and the like were caused by rolling for a larger area in this Comparative Example, production by roll-to-roll allowed to be performed in each Example was difficult in this Comparative Example.

The water vapor transmission rate of the flexible transparent conductive film (at a portion where rolling was allowed to be conducted relatively uniformly) according to Comparative Example 3 was measured to find that its water vapor transmission rate was about 1.0 g/m²/day (the initial water vapor transmission rate of the GX Film was 0.04 g/m²/day), so that the water vapor transmission rate was considerably deteriorated due to the rolling in the course of forming the transparent conductive layer.

Next, using the flexible transparent conductive film (at the portion where rolling was allowed to be conducted relatively uniformly) according to Comparative Example 3, the subsequent procedure of Example 1 was substantially repeated to obtain a flexible functional device (electronic paper device) according to Comparative Example 3 (thickness of the device: about 67 μm).

This about 67 μm thick flexible functional device (electronic paper device) according to Comparative Example 3 is constituted of “about 13 μm thick first base film having been provided with gas barrier function”/“about 0.5 μm thick first transparent conductive layer”/“display layer (thickness: 40 μm)”/“about 0.5 μm thick second transparent conductive layer”/“about 13 μm thick second base film having been provided with gas barrier function”, and its flexibility was at the same level as that of the flexible functional device (electronic paper device) according to Example 1 having a total thickness of about 67 μm.

Then, like Example 1, a DC voltage of 10 V was applied across the Ag lead wires for applying voltage, of the flexible functional device (electronic paper device) according to Comparative Example 3, and the polarity was repeatedly reversed, whereupon white and black were alternately repeatedly displayed.

However, the flexible transparent conductive films were each extremely thin and brought a considerable difficulty in its handling in the production steps of the flexible functional device, so that the manufacturing efficiency of the device was considerably deteriorated, and variances of the obtained device performances (displaying performances such as display speed, contrast, and the like) were considerably increased.

Further, the flexible transparent conductive film of Comparative Example 3 was considerably deteriorated in water vapor transmission rate as described above, thus it was ascertained that the flexible functional device of Comparative Example 3 was considerably deteriorated in device performance when the obtained flexible functional device was left to stand in the atmospheric air for a long time, though changes were not found in device performances (display performances such as display speed, contrast, and bistability) in the flexible functional device of each Example.

### Comparative Example 4

An alumina gas barrier layer (thickness: about 50 nm) was formed by sputtering over a whole surface of one side of a PET film having a thickness of 100 μm, and the PET film was, on the PET film surface on which the gas barrier layer was not formed, subjected to corona discharge treatment, to obtain a plastic film having a thickness of about 100 μm and provided with gas barrier function. This film had a water vapor transmission rate of 0.02 g/m²/day.

The subsequent procedure of Example 1 was repeated except that the above plastic film of about 100 μm thickness, having been provided with gas barrier function was used as a base film instead of the plastic film (GX Film) of Example 1 of about 13 μm in thickness, having been provided with gas barrier function, and except that the support film (backing film) was not laminated to the base film, to obtain a transparent conductive film (thickness of the base film with transparent conductive layer: about 100.5 μm) according to Comparative Example 4 including a transparent conductive layer (layer thickness: about 0.5 μm) made up of fine ITO particles filled densely therein and a binder matrix, on the base film.

The water vapor transmission rate of the obtained transparent conductive film according to Comparative Example 4 was measured to find that its water vapor transmission rate was about 0.08 g/m²/day, so that the water vapor transmission rate came to slightly deteriorate because of the rolling and so forth carried out in the course of forming the transparent conductive layer, possibly because the gas barrier layer was made up of a simple substance of alumina being a brittle inorganic material.

Next, using the transparent conductive film according to Comparative Example 4, the subsequent procedure of Example 1 was substantially repeated to obtain a functional device (electronic paper device) according to Comparative Example 4 (thickness of the device: about 241 μm). This about 241 μm thick functional device (electronic paper device) according to Comparative Example 4 is constituted of “about 100 μm thick plastic film having been provided with gas barrier function”/“about 0.5 μm thick first transparent conductive layer”/“display layer (thickness: 40 μm)”/“about 0.5 μm thick second transparent conductive layer”/“about 100 μm thick plastic film having been provided with gas barrier function”, and its flexibility was considerably inferior to that of the flexible functional device (electronic paper device) according to Example 1 having a total thickness of about 67 μm.

Then, like Example 1, a DC voltage of 10 V was applied across the Ag lead wires for applying voltage, of the functional device (electronic paper device) according to Comparative Example 4, and the polarity was repeatedly reversed, whereupon white and black were alternately repeatedly displayed.

### Comparative Example 5

An alumina gas barrier layer (thickness: about 50 nm) was formed by sputtering over a whole surface of one side of a PET film having a thickness of 75 μm, and the PET film was, on the PET film surface on which the gas barrier layer was not formed, subjected to corona discharge treatment, to obtain a plastic film having a thickness of about 75 μm and provided with gas barrier function. This film had a water vapor transmission rate of 0.02 g/m²/day.

The subsequent procedure of Example 1 was repeated except that the above plastic film of about 75 μm thickness, having been provided with gas barrier function was used as a base film instead of the plastic film (GX Film) of Example 1 of about 13 μm in thickness, having been provided with gas barrier function, and except that the support film (backing film) was not laminated to the base film, to obtain a transparent conductive film (thickness of the base film with transparent conductive layer: about 75.5 μm) according to Comparative Example 5 including a transparent conductive layer (layer thickness: about 0.5 μm) made up of fine ITO particles filled densely therein and a binder matrix, on the base film.

The water vapor transmission rate of the obtained transparent conductive film according to Comparative Example 5 was measured to find that its water vapor transmission rate was about 0.1 g/m²/day, so that the water vapor transmission rate came to slightly deteriorate because of the rolling and so forth carried out in the course of forming the transparent conductive layer, possibly because the gas barrier layer was made up of a simple substance of alumina being a brittle inorganic material.

Next, using the transparent conductive film according to Comparative Example 5, the subsequent procedure of Example 1 was substantially repeated to obtain a functional device (electronic paper device) according to Comparative Example 5 (thickness of the device: about 191 μm). This about 191 μm thick functional device (electronic paper device) according to Comparative Example 5 is constituted of “about 75 μm thick plastic film having been provided with gas barrier function”/“about 0.5 μm thick first transparent conductive layer”/“display layer (thickness: 40 μm)”/“about 0.5 μm thick second transparent conductive layer”/“about 75 μm thick plastic film having been provided with gas barrier function”, and its flexibility was considerably inferior to that of the flexible functional device (electronic paper device) according to Example 1 having a total thickness of about 67 μm.

Then, like Example 1, a DC voltage of 10 V was applied across the Ag lead wires for applying voltage, of the functional device (electronic paper device) according to Comparative Example 5, and the polarity was repeatedly reversed, whereupon white and black were alternately repeatedly displayed.

### POSSIBILITY OF INDUSTRIAL APPLICATION

According to the flexible functional device such as a liquid-crystal display device, organic electroluminescent device, dispersion-type inorganic electroluminescent device or electronic paper device making use of the flexible transparent conductive film of the present invention, the flexible functional device has a thickness kept relatively small to have a superior flexibility, and hence has a possibility of industrial application that it is utilized in thin-gauge equipments such as cards.

1. A flexible transparent conductive film having a base film and a transparent conductive layer formed by coating the base film surface with a transparent conductive layer forming coating fluid, wherein;
the base film is constituted of a plastic film of 3 to 50 μm in thickness having been provided with gas barrier function, the flexible transparent conductive film has a backing film laminated to one side of the base film in such a way as to be peelable at the interface thereof with the base film, the transparent conductive layer provided on the base film surface on its side opposite to the backing film is chiefly composed of conductive fine oxide particles and a binder matrix, and the transparent conductive layer has been subjected to compressing together with the base film and the backing film.

2. The flexible transparent conductive film according to claim 1, wherein the base film is constituted of a plurality of plastic films having been provided with gas barrier function which have been laminated to each other, the gas barrier function of which base film has been reinforced.

3. The flexible transparent conductive film according to claim 2, wherein the plastic film has been subjected to gas barrier coating so as to be provided with the gas barrier function.

4. The flexible transparent conductive film according to claim 3, wherein the gas barrier coating comprises at least one vapor-deposited film made of an inorganic material and at least one coated film containing an organic material, the vapor-deposited film and the coated film being layered with each other.

5. The flexible transparent conductive film according to claim 4, wherein the transparent conductive layer is formed on a gas barrier film of the plastic film having been subjected to gas barrier coating.

6. The flexible transparent conductive film according to claim 1, wherein the conductive fine oxide particles of the transparent conductive layer are chiefly composed of at least one of indium oxide, tin oxide and zinc oxide.

7. The flexible transparent conductive film according to claim 6, wherein the conductive fine oxide particles composed chiefly of indium oxide are fine indium-tin oxide particles.

8. The flexible transparent conductive film according to claim 1, wherein the binder matrix of the transparent conductive layer has been cross-linked to have resistance to an organic solvent.

9. The flexible transparent conductive film according to claim 1, wherein the compressing has been carried out by rolling with rolls.

10. A method for producing a flexible transparent conductive film which method comprises:
laminating, to one side of a base film constituted of a plastic film of 3 to 50 μm in thickness, having been provided with gas barrier function, a backing film in such a way as to be peelable at the interface thereof with the base film;
coating the base film surface on its side opposite to the backing film, with a transparent conductive layer forming coating fluid composed chiefly of conductive fine oxide particles, a binder and a solvent, to form a coating layer;
subjecting the base film on which the coating layer has been formed, the base film having the backing film on its one side, to compressing; and thereafter
curing the coating layer to form a transparent conductive layer.

11. The method for producing a flexible transparent conductive film according to claim 10, wherein the base film is constituted of a plurality of plastic films having been provided with gas barrier function, the gas barrier function of which base film has been reinforced.

12. The method for producing a flexible transparent conductive film according to claim 11, wherein the plastic film has been subjected to gas barrier coating so as to be provided with the gas barrier function.

13. The method for producing a flexible transparent conductive film according to claim 10, wherein the compressing is carried out by rolling with rolls.

14. The method for producing a flexible transparent conductive film according to claim 13, wherein the compressing is carried out under conditions of a linear pressure of from 29.4 N/mm to 490 N/mm (from 30 kgf/cm to 500 kgf/cm).

15. A flexible functional device which comprises:
the flexible transparent conductive film according to claim 10, and formed on its side opposite to the backing film any functional device selected from a liquid-crystal display device, an organic electroluminescent device, a dispersion-type inorganic electroluminescent device and an electronic paper device;
the backing film having been removed by peeling the same at the interface thereof with the base film.

16. A method for producing a flexible functional device which method comprises:
forming on the flexible transparent conductive film according to claim 1 and on its side opposite to the backing film any functional device selected from a liquid-crystal display device, an organic electroluminescent device, a dispersion-type inorganic electroluminescent device and an electronic paper device; and
removing the backing film by peeling the same at the interface thereof with the base film.

17. A flexible functional device which comprises:
the flexible transparent conductive film according to claim 1, and formed on its side opposite to the backing film any functional device selected from a liquid-crystal display device, an organic electroluminescent device, a dispersion-type inorganic electroluminescent device and an electronic paper device;
the backing film having been removed by peeling the same at the interface thereof with the base film.

18. The flexible transparent conductive film according to claim 1, wherein the plastic film has been subjected to gas barrier coating so as to be provided with the gas barrier function.

19. The flexible transparent conductive film according to claim 3, wherein the transparent conductive layer is formed on a gas barrier film of the plastic film having been subjected to gas barrier coating.

20. The method for producing a flexible transparent conductive film according to claim 10, wherein the plastic film has been subjected to gas barrier coating so as to be provided with the gas barrier function.
